(19) United States
(12) Patent Application Publication
(10) Pub. No.: US 2017/0013311 A1
(43) Pub. Date: Jan. 12, 2017

(54) NOTIFICATION COMMUNICATION BETWEEN FRONT AND REAR ENTERTAINMENT SYSTEMS

(71) Applicant: Honda Motor Co., Ltd., Tokyo (JP)

(72) Inventors: Parhys L. Napier, Hillard, OH (US); Jessica K. Champi, Columbus, OH (US)

(21) Appl. No.: 14/795,086

(22) Filed: Jul. 9, 2015

(51) Int. Cl. H04N 21/4627; H04N 21/488; H04N 21/436; H04N 21/414; H04N 21/442

(52) U.S. Cl. CPC H04N 21/4627; H04N 21/41422; H04N 21/44231; H04N 21/44222; H04N 21/436; H04N 21/4882

(57) ABSTRACT

An interactive notification communication between front and rear entertainment systems in a vehicle is provided. A first system receives a request that indicates a second system is attempting to access content. The access attempt may be a purchase, a download, a view, or other actions performed on the content. The request is selectively granted or denied based on various criteria including, the type of content. If the access request is denied, a notice is sent to the second system and the action is canceled. If the access request is granted, a notice is sent to the second system and the action being performed is allowed to proceed.

### BACKGROUND

Vehicle information and entertainment systems, referred to as infotainment systems, are increasing in popularity. Infotainment systems in vehicles include hardware and/or software products and systems that are included in vehicles (e.g., built into or added to the vehicle). These infotainment systems may enhance the experience of a driver and/or passengers.

The driver and passengers are able to view their respective displays and consume the information provided by the respective infotainment system. Since each infotainment system is intended for consumption at the different seat locations in the vehicle, others within the vehicle may not be able to monitor what the other people in the vehicle are doing. This may be a concern for parents, who may be located in a front portion of a vehicle and, therefore, cannot monitor what a child, who may be located in a back portion of vehicle, is consuming on their respective infotainment system.

### BRIEF DESCRIPTION

This brief description is provided to introduce a selection of concepts in a simplified form as compared to that described below in the detailed description. This brief description is not intended to be an extensive overview of the claimed subject matter, identify key factors or essential features of the claimed subject matter, nor is it intended to be used to limit the scope of the claimed subject matter.

An implementation relates to an entertainment system for notification communication between vehicle entertainment systems. The entertainment system may include a processor that executes computer executable components stored in a memory. The computer executable components may include an interface component that outputs a first set of content at the entertainment system, independent of another entertainment system that outputs a second set of content. The computer executable components may also include an obtainment component that receives an indication that the other entertainment system is attempting to access a third set of content and an authorization component that controls access to the third set of content by the other entertainment system. According to an implementation, the computer executable components may include an announcement component that provides details related to the third set of content.

In an aspect, the authorization component grants access to the third set of content based upon a determination that access to the third set of content is approved. In another aspect, the authorization component prohibits access to the third set of content based on a determination that access to the third set of content is denied.

According to an aspect, the interface component outputs the first set of content and the indication on a display screen. According to another aspect, the indication is overlaid on a portion of the first set of content. According to a further aspect, the indication comprises data related to a purchase of the third set of content. In accordance with another aspect, the indication comprises data related to a download of the third set of content.

In an aspect, the interface component outputs the first set of content audibly. Further to this aspect, the output of the first set of content is paused during the output of the indication.

The entertainment system and the other entertainment system may comprise a master slave relationship, according to an aspect.

Another implementation relates to a method for providing interactive notification communication between at least two systems. The method includes receiving, by a first system comprising a processor, a request for access to content by a second system, wherein the request is received from the second system. The method may also include determining, by the first system, to grant or deny access to the content by the second system. Further, the method may include transmitting, by the first system, an authorization to access the content based on a determination to grant access to the content, or a denial to access the content based on another determination to deny access to the content, wherein the first system and the second system operate independently.

According to an aspect, determining to grant or deny access may include outputting a notification of the request for access and details related to the content. Further to this aspect, the method may include determining, based on receipt of a first selection that access to the content is approved and, based on another receipt of a second selection that access to the content is denied.

According to another aspect, receiving the request may include receiving the request based on an attempt to purchase the content at the second system. According to another aspect, receiving the request may include receiving the request based on an attempt to download the content at the second system.

A further implementation relates to an entertainment system for notification communication between entertainment systems. The entertainment system may include a processor that executes computer executable components stored in a memory. The computer-executable components may include an interface component that outputs a first set of content independent of another entertainment system that outputs a second set of content. The computer-executable components may also include a notification component that conveys an indication to the other entertainment system based on a determination that the entertainment system is attempting to access a third set of content. Further, the computer-executable components may include an output component that allows access to the third set of content based on receipt of a grant access authorization from the other entertainment system. Alternatively, the output component prohibits access to the third set of content based on a denial of the grant access authorization from the other entertainment system.

According to an aspect, the computer executable components may also include a status indictor component that renders an indication of a state of the grant access authorization from the other entertainment system. In an aspect, the access is an attempt to purchase the third set of content. In another aspect, the access is an attempt to download the third set of content. According to another aspect, the interface component outputs the first set of content on a first display screen.

The following description and annexed drawings set forth certain illustrative aspects and implementations. These are indicative of but a few of the various ways in which one or more aspects may be employed. Other aspects, advantages, or novel features of the disclosure will become apparent from the following detailed description when considered in conjunction with the annexed drawings.

### BRIEF DESCRIPTION OF THE DRAWINGS

Aspects of the disclosure are understood from the following detailed description when read with the accompanying drawings.

FIG. 1 illustrates an example, non-limiting system configured for notification communication between entertainment systems, according to an aspect.

FIG. 2 illustrates another example, non-limiting system configured for notification communication between entertainment systems, according to an aspect.

FIG. 3 illustrates example, non-limiting representations of respective displays for a front entertainment system and a rear entertainment system, according to an aspect.

FIG. 4 illustrates example, non-limiting display screens for a situation where the content access is authorized, according to an aspect.

FIG. 5 illustrates example, non-limiting display screens for a situation where the content access is denied, according to an aspect.

FIG. 6 illustrates an example, non-limiting representation of a purchase attempt, according to an aspect.

FIG. 7 illustrates an example, non-limiting representation of a status indication, according to an aspect.

FIG. 8 illustrates an example, non-limiting representation of approval of a purchase request, according to an aspect.

FIG. 9 illustrates an example, non-limiting representation of denial of a purchase request, according to an aspect.

FIG. 10 illustrates an example, non-limiting representation of a download attempt, according to an aspect.

FIG. 11 illustrates an example, non-limiting representation of confirmation of a download attempt, according to an aspect.

FIG. 12 illustrates an example, non-limiting representation of denial of a download request.

FIG. 13 illustrates an example, non-limiting system for communication between at least two infotainment apparatuses, according to an aspect.

FIG. 14 illustrates an example non-limiting method configured for notification communication between entertainment systems, according to an aspect.

FIG. 15 illustrates an example, non-limiting method for selectively granting access to content, according to an aspect.

FIG. 16 illustrates an example, non-limiting method for accessing content on a supervised device, according to an aspect.

FIG. 17 illustrates an example, non-limiting method for communication notifications between at least two infotainment systems, according to an aspect.

FIG. 18 illustrates an example, non-limiting computer-readable medium or computer-readable device including processor-executable instructions configured to embody one or more of the aspects set forth herein.

FIG. 19 illustrates an example, non-limiting computing environment where one or more of the aspects set forth herein are implemented, according to one or more embodiments.

### DETAILED DESCRIPTION

Embodiments or examples, illustrated in the drawings are disclosed below using specific language. It will nevertheless be understood that the embodiments or examples are not intended to be limiting. Any alterations and modifications in the disclosed embodiments, and any further applications of the principles disclosed in this document are contemplated as would normally occur to one of ordinary skill in the pertinent art.

The disclosed aspects provide communications between at least one front entertainment system and at least one rear entertainment system. The communications allows occupants of a vehicle to be aware of what other occupants are attempting to access (e.g., view, download, purchase, or actions being performed on their respective entertainment systems). Further, the disclosed aspects provide interactive communication between at least two entertainment systems (e.g., between front and rear entertainment systems) in a vehicle. Such interactive communication may occur during a purchase and/or download of content (e.g., TV programs, movies, games, etc.), as well as other times.

For example, applications in a vehicle's entertainment system allow the occupants to download and stream content on an “as desired” basis. This may be alarming to parents if their children are able to download and stream content that is not appropriate for the child. Thus, various aspects disclosed herein provide notifications communication between the front and rear entertainment systems (or between other entertainment systems). For example, the notifications communication may allow a front passenger (e.g., parents) to be aware of what their kids are doing. Further, notifications communication may allow the front passenger to control the content the rear passengers have access to, including explicit content, content downloads, unauthorized purchases, and so on.

As used herein, an occupant of the vehicle may include a driver of the vehicle, an operator of the vehicle, an individual, an entity, a person, a passenger, and so on. Further, as used herein, an operator of a vehicle may be a driver of a vehicle or an occupant who provides one or more vehicle operations or commands to the vehicle, such as steering commands, for example.

According to an implementation, an occupant of a vehicle may be a parent, a teacher, or another person in a position of authority (e.g., an adult) and another occupant of the vehicle may be a child. Thus, it may be beneficial for the adult to monitor the activities of the child especially where the adult and the child are located in remote portions of the vehicle. For example, the adult may be a front passenger and the child may be a rear passenger. In another example, one adult might be at the middle portion (or front portion) of a bus and a second adult may be at a rear portion of the bus and children may be dispersed throughout the bus. In this case, each adult might be provided the ability to monitor the entertainment system activities of at least a subset of the children (or each adult may monitor the entire group of children). For example, the adult located at the front portion of the bus might monitor a first set of children at the front of the bus and the adult located at the rear portion of the bus might monitor a second set of children located at the rear portion of the bus.

In some cases, a parent might be a front passenger and a child might be a rear passenger. However, the disclosed aspects are not limited to this implementation, and a parent might be a rear passenger while a child is a front passenger. According to some implementations, the parent may be a driver of the vehicle. Further, the relationship between the passengers may be different from a parent-child relationship. For example, the passengers might be friends and an owner of the vehicle might want to limit access to what their friends may do with the entertainment system (e.g., not allow unauthorized purchases, not allow social media communications from the friends that might be done in “fun,” and so on).

According to some implementations, the interaction between entertainment systems may be a one-to-one relationship (e.g., a first entertainment system (parent) and a second entertainment system (child)). According to another implementation, the interaction may be a one-to-many relationship (e.g., a first entertainment system (a parent) that interfaces with a second entertainment system (a first child) and at least a third entertainment system (a second child)). In accordance with another implementation, the interaction may be a many-to-one relationship (e.g., a first entertainment system (first parent), a second entertainment system (second parent), a third entertainment system (child)), where either (or both) the first and second entertainment systems may control access of content by the third entertainment system. In yet another implementation, the relationship between the entertainment systems may be a many-to-many relationship (e.g., a first entertainment system (first parent), a second entertainment system (second parent), a third entertainment system (a first child), and a fourth entertainment system (e.g., a second child)).

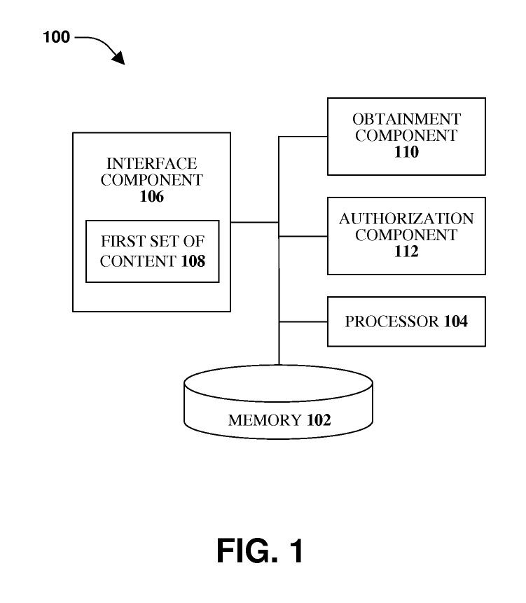

FIG. 1 illustrates an example, non-limiting system 100 configured for notification communication between entertainment systems, according to an aspect. The system 100 of FIG. 1 may be associated with at least a first entertainment system, such as an entertainment system associated with a parent or other entity in a position of authority.

For example, multiple entertainment systems may be located in a vehicle. As discussed herein the term “vehicle” includes various means of transportation. For example, a vehicle may be a land vehicle (e.g., an automobile, a pickup truck, a minivan, a bus, a truck and fifth wheel combination, a recreational vehicle, a semi-trailer truck, and so forth), an amphibious vehicle, a water craft (e.g., a boat, a ship, a hovercraft, and so on), an aircraft, a road-rail vehicle, a rail vehicle, and so on.

The system 100 may include at least one memory 102 that may store computer executable components and/or computer executable instructions. The system 100 may also include at least one processor 104, communicatively coupled to the at least one memory 102. The at least one processor 104 may facilitate execution of the computer executable components and/or the computer executable instructions stored in the memory 102. The term “coupled” or variants thereof may include various communications including, but not limited to, direct communications, indirect communications, wired communications, and/or wireless communications.

It is noted that although the one or more computer executable components and/or computer executable instructions may be illustrated and described herein as components and/or as instructions separate from the memory 102 (e.g., operatively connected to the memory 102), the various aspects are not limited to this implementation. Instead, in accordance with various implementations, the one or more computer executable components and/or the one or more computer executable instructions may be stored in (or integrated within) the memory 102. Further, while various components and/or instructions have been illustrated as separate components and/or as separate instructions, in some implementations, multiple components and/or multiple instructions may be implemented as a single component or as a single instruction. Further, a single component and/or a single instruction may be implemented as multiple components and/or as multiple instructions without departing from the example embodiments.

The system 100 may also include an interface component 106 that may be configured to output a first set of content 108. For example, the first set of content 108 may be output at the first entertainment system. According to an aspect, the first set of content may be output in a visual format, an audible format, or in another type of format that is perceivable to a user of the first entertainment system (e.g., parent, adult, babysitter, and so on).

The first set of content 108 may be various types of content that provides information and/or entertainment value. Such content includes word processing programs, Internet or web browsing, streaming movies or other streaming content, and so on. Further, the first set of content 108 output by the interface component 106 may be independent of a second set of content that is output by a second entertainment system (e.g., an entertainment system used by a child).

According to some implementations, the interface component 106 (as well as other interface components discussed herein) may provide a graphical user interface (GUI), a command line interface, a speech interface, Natural Language text interface, and the like. For example, a GUI may be rendered that provides a user with a region or means to load, import, select, read, and so forth, various requests and may include a region to present the results of the various requests. These regions may include known text and/or graphic regions that include dialogue boxes, static controls, drop-down-menus, list boxes, pop-up menus, as edit controls, combo boxes, radio buttons, check boxes, push buttons, graphic boxes, and so on. In addition, utilities to facilitate the information conveyance, such as vertical and/or horizontal scroll bars for navigation and toolbar buttons to determine whether a region will be viewable, may be employed. Thus, it might be inferred that the user did want the action performed.

The user may also interact with the regions to select and provide information through various devices such as a mouse, a roller ball, a keypad, a keyboard, a pen, gestures captured with a camera, a touch screen, and/or voice activation, for example. According to an aspect, a mechanism, such as a push button or the enter key on the keyboard, may be employed subsequent to entering the information in order to initiate information conveyance. However, it is to be appreciated that the disclosed aspects are not so limited. For example, merely highlighting a check box may initiate information conveyance. In another example, a command line interface may be employed. For example, the command line interface may prompt the user for information by providing a text message, producing an audio tone, or the like. The user may then provide suitable information, such as alphanumeric input corresponding to an option provided in the interface prompt or an answer to a question posed in the prompt. It is to be appreciated that the command line interface may be employed in connection with a GUI and/or API. In addition, the command line interface may be employed in connection with hardware (e.g., video cards) and/or displays (e.g., black and white, and EGA) with limited graphic support, and/or low bandwidth communication channels.

The system 100 may also include an obtainment component 110 that may be configured to receive an indication that the second entertainment system is attempting to access a third set of content. For example, the access attempt by (or at) the second entertainment system may be an attempt to purchase content. In another example, the access attempt by (or at) the second entertainment system may be an attempt to download content. Further, other types of access attempts may be made at (or by) the second entertainment system, wherein such access attempts trigger an authorization procedure to be performed as discussed herein.

Also included in the system 100 may be an authorization component 112 that may be configured to control access to the third set of content by the second entertainment system. For example, the access to the third set of content may be authorized and the access at the second entertainment system is allowed to continue (e.g., content may be purchased, content may be downloaded, content may be viewed, content may be transmitted, and so on).

In another example, the access to the third set of content may be denied. Accordingly, the access at the second entertainment system is prohibited and the user is not able to perform the desired action (e.g., download, purchase, view, and so on). Further, the user may be provided an indication that the access has been denied (e.g., an error message on the screen, an audible notification, and so on).

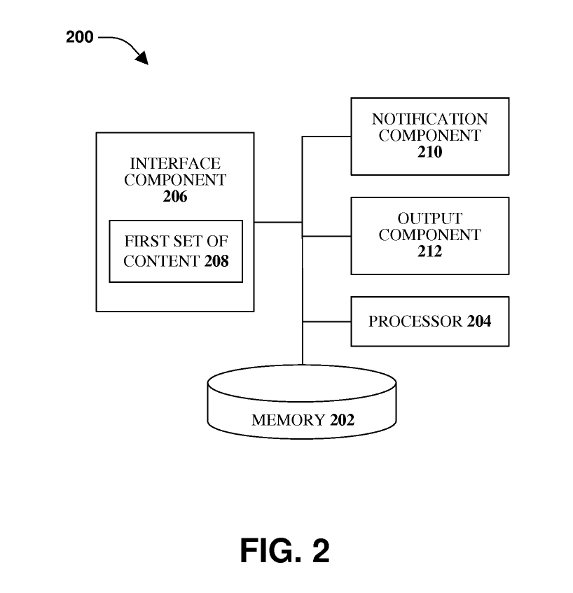

FIG. 2 illustrates another example, non-limiting system 200 configured for notification communication between entertainment systems, according to an aspect. The system 200 of FIG. 2 may be associated with at least a first entertainment system, such as an entertainment system associated with a child or other entity being supervised.

The system 200 may include at least one memory 202 that may store computer executable components and/or computer executable instructions. The system 200 may also include at least one processor 204, communicatively coupled to the at least one memory 202. The at least one processor 204 may facilitate execution of the computer executable components and/or the computer executable instructions stored in the memory 202.

Also included in the system 200 may be an interface component 206 that may be configured to output a first set of content 208. The first set of content 208 may be independent of at least a second set of content output by other systems (e.g., other entertainment systems or entertainment apparatuses). The first of set of content 208 may be output in various perceivable formats including, but not limited to, a visual format and an audible format.

A notification component 210 may be configured to convey an indication to a second system based on a determination that access of a third set of content is being attempted. The access attempt may be based on a request to view content, download content, purchase content, communication content, and other actions performed with respect to content.

An output component 212 may be configured to allow access to the content or prohibit access to the content based on a response received from the second system. For example, based on receipt of a grant access from the second system, access to the third set of content is allowed. Alternatively, based on receipt of denial of the grant access from the second system, access to the third set of content is prohibited.

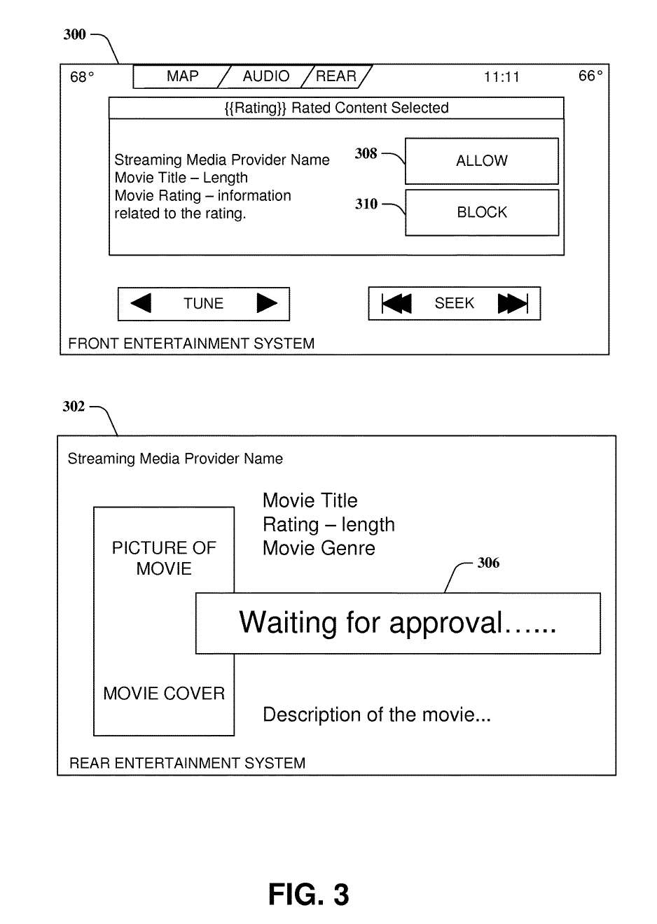

FIG. 3 illustrates example, non-limiting representations of respective displays for a front entertainment system 300 and a rear entertainment system 302, according to an aspect. It is noted that although the terms “front” and “rear” are utilized herein, the disclosed aspects are not limited to this implementation. Instead, such terms are used to distinguish a controller (master or supervising) entertainment system (e.g., front or parent) from a controlled (slave or supervised) entertainment system (e.g., back or child). Thus, according to various aspects, an entertainment system described as a “front” system may be located at a rear portion (or other portion) of a vehicle. Further, an entertainment system described as a “rear” system may be located at a front portion (or other portion) of the vehicle. Further, although only two entertainment systems are illustrated and described, more than two entertainment systems may be utilized according to various implementations.

As illustrated, the front entertainment system 300 and the rear entertainment system 302 may operate independently, wherein each system outputs respective content, such as on respective displays, as illustrated. For example, the front entertainment system 300 may include various features, such as temperature indications (e.g., external temperature, internal temperature, and so forth). Further, the front entertainment system 300 may include a time indication, as well as radio control buttons (e.g., tune, seek), and so on. It is contemplated that although such features are illustrated and described with respect to the front entertainment system 300, such features may additionally or alternatively be displayed on the rear entertainment system 302.

At about the same time as content is accessed (or attempted to be accessed) at the rear entertainment system 302, a notification may be sent to the front entertainment system 300. In this example, the content attempting to be accessed is a movie. Thus, the rear entertainment system 302 may display information related to the movie, such as a movie cover (e.g., film poster), the movie title, rating, length, movie genre or type (e.g., action, science fiction, drama, humor, romance, historical, and so on), as well as a brief description of the movie. While waiting for approval to be received from the front entertainment system 300, a status notification 306 may be output at the rear entertainment system 302 that indicates approval is needed for a next action to be performed. The status notification 306 may be laid over other information output on the rear entertainment system 302. According to an implementation, the status notification 306 may be transparent. In this manner, the other information may be viewed and may appear to be placed behind the status notification 306.

According to some implementations, a cancel button (e.g., icon, verbal command, and so forth) may be utilized to cancel the request. In accordance with another implementation, a session time-out may be utilized, wherein if approval is not received from the front entertainment system 300 within a configurable amount of time (e.g., two minutes, three and a half minutes, five minutes, and so on), the access attempt is automatically denied.

At about the same time as the access attempt request is transmitted from the rear entertainment system 302 to the front entertainment system 300, information related to the request is rendered at the front entertainment system 300. In this example, the information provided includes the rating of the movie (e.g., PG-13 Rated Content Selected, R Rated Content Selected). Also displayed may be information related to the streaming media content provider name (e.g., an identification of a provider of on-demand Internet streaming media available to viewers), the movie title, and the movie length. Other information may be displayed, such as the movie rating, a description of the rating, and why the movie was given the particular rating. For example, a movie may have a rating of PG-13 and the information provided may be “Rated PG-13 for intense violent thematic material and disturbing images.” In another example, the rating may be “Rated R for pervasive language, some sexual content and brief violence. Additionally or alternatively, other information that would be helpful to perform the authorization procedure may be provided. In some implementations, the information rendered may be configurable such that a user of the front entertainment system 300 may select the information desired, and may request additional information in order to make a decision.

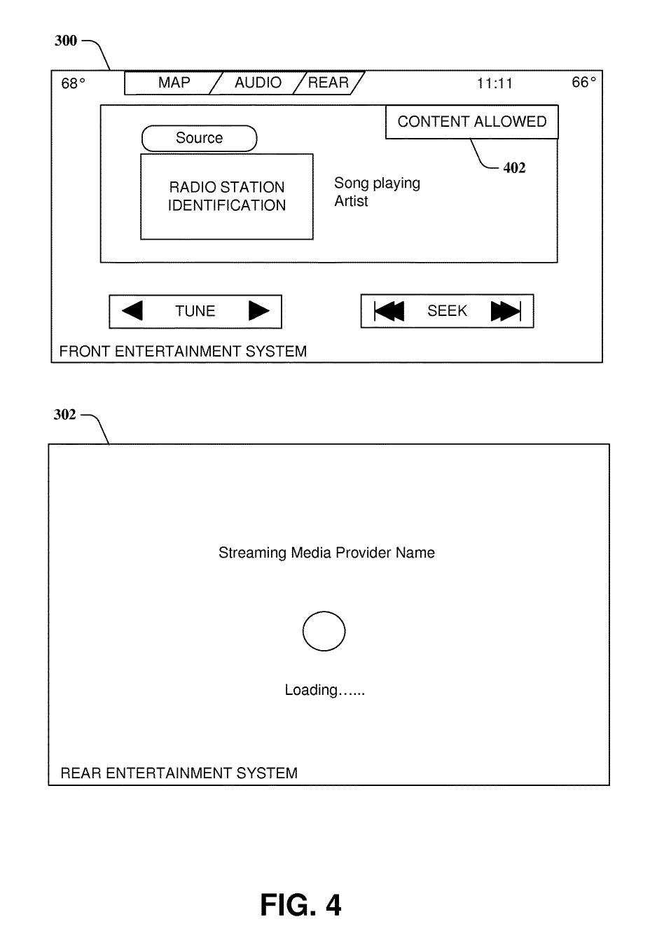

Also included with the front entertainment system 300 may be an allow selector 308 and a block selector 310. In the situation where the access attempt is authorized and the allow selector 308 is touched, energized, a verbal command is received, and so forth, the front entertainment system 300 and rear entertainment system 302 output the data as illustrated in FIG. 4, which illustrates example, non-limiting display screens for the situation where the content access is authorized.

A notice 402 confirming the content is allowed may be displayed on the screen of the front entertainment system 300, at least temporarily. Further, the notice 402 may be transparent such that information located behind the notice 402 may be viewed and the notice 402 appears to be overlaid on the information. Further, once the content is allowed, the front entertainment system 300 may resume a previous operation. In this example, the user of the front entertainment system 300 was listening to the radio. Thus, the display screen illustrates the radio information.

Further, at about the same time as content access is authorized (e.g., in real-time, in near real-time, after a delay, and so on), the rear entertainment system 302 may begin to download content. Thus, a display screen of the rear entertainment system 302 may indicate that the content is loading.

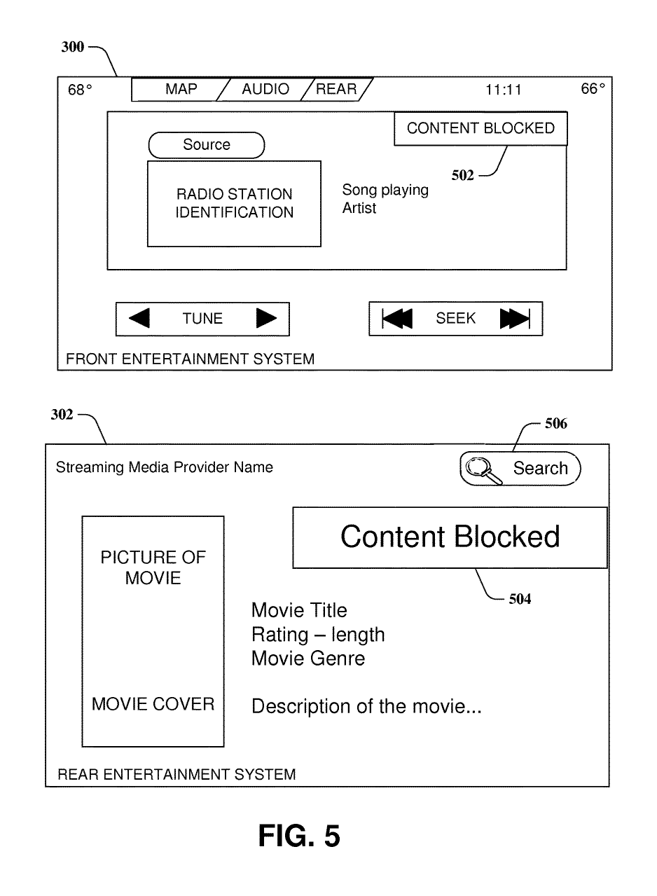

In the situation where the access attempt is not authorized (e.g., the block selector 310 is touched, energized, a verbal command is received, and so forth, the front entertainment system 300 and rear entertainment system 302 output the data as illustrated in FIG. 5, which illustrates example, non-limiting display screens for the situation where the content access is denied.

A notice 502 confirming the content is denied may be displayed on the screen of the front entertainment system 300, at least temporarily. Further, the notice 502 may be transparent such that information located behind the notice 502 may be viewed and the notice 502 appears to be overlaid on the information. According to some implementations, the notice 502 (and/or notice 402 of FIG. 4) may be a different color, a different font, or have other characteristics that highlight or bring attention to the notice 502 (or notice 402). Further, once the content is denied, the front entertainment system 300 resumes operation. In this example, the user of the front entertainment system 300 was listening to the radio. In some implementations, depending on the operation being performed at the front entertainment system 300, the operation is not paused. For example, a radio operation might not be paused; however, a movie might be paused.

At about the same time as content access is denied or prohibited (e.g., in real-time, in near real-time, after a delay, and so on), the rear entertainment system 302 renders a denial message 504 that indicates the content is blocked. A search module 506 may allow the user of the rear entertainment system 302 the ability to perform another search for content that is of interest to the user and that will be authorized for download and viewing. Similar to notice 502, the denial message 504 may be displayed in a different color, a different font, or have other characteristics that highlight or bring attention to the denial message 504.

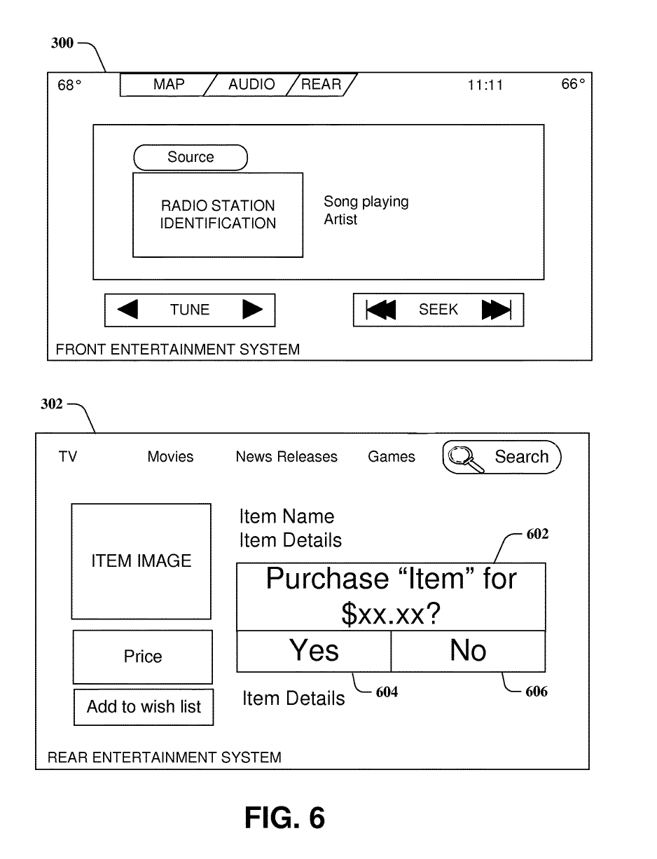

FIG. 6 illustrates an example, non-limiting representation of a purchase attempt, according to an aspect. As illustrated, the front entertainment system 300 and the rear operating system 302 are operating independently. For example, a user of the front entertainment system 300 is enjoying listening to the radio and the user of the rear entertainment system 300 would like to purchase a game or a movie.

As illustrated on the rear entertainment system 302, the user is provided options, such as TV, Movies, News Releases, Games, and search, for example. Thus, the user may select different types of content as desired. In this example, the user would like to purchase a game or other item. Thus, as the user is operating and navigating through screens of the rear entertainment system 302, various information related to the item are displayed. Such information may include an item image, a price, and an option to add to a “wish list.” Further information and/or item details may also be provided. The user may select a buy function and confirmation 602 of the purchase request might be displayed. In this example, the confirmation 602 states “Purchase ‘Item” for $xx.xx?” where the item refers to the name of the product and $xx.xx refers to the purchase price. The user is also provided a first confirmation 604 (e.g., “Yes”) and a second confirmation 606 (e.g., “No”).

If the user decides to cancel the purchase, the second confirmation 606 (e.g., “No”) is selected. In this scenario, the purchase request is canceled and the user may proceed to search for another item. Further to this scenario, no communication is transmitted to the first entertainment system 300.

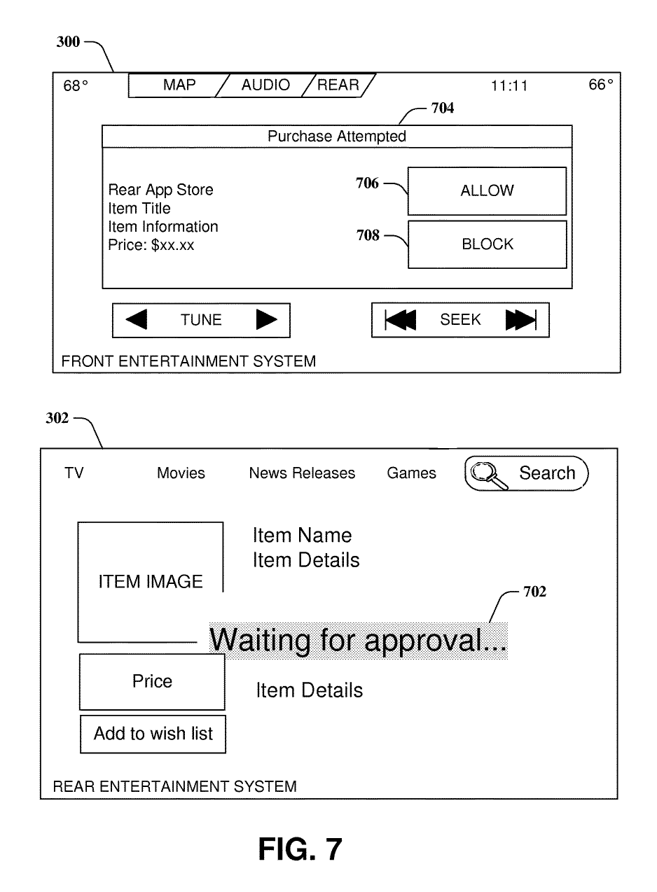

Alternatively, if the user decides to go through with the purchase, the first confirmation 604 is selected. At about the same time as the first confirmation is selected, the information is provided to the front entertainment system 300, as illustrated in FIG. 7. The rear entertainment system 302 may output a status notification 702 that indicates authorization has been requested from the front entertainment system 700 (e.g., “Waiting for approval . . . ”).

At the front entertainment system 300, in this example, a purchase attempt screen 704 is output (and an operation at the front entertainment system 300 may be temporarily paused). The purchase attempt screen 704 may include information related to the entertainment system attempting to purchase the item. In this example, the rear entertainment system 302 (e.g., rear) is attempting the purchase. However, if two or more entertainment systems are being monitored, information related to which entertainment system the request has been received from may be displayed.

In this example, the purchase attempt screen 704 may also include information from where the item is attempted to be purchased (e.g., app store or other source). Additional information may also be provided, such as item title, item information, and item price.

Two selections are provided through an interface of the front entertainment system 300. A first selection 706 enables authorization of the purchase request (e.g., Allow) and a second selection 708 denies authorization of the purchase request (e.g., Block).

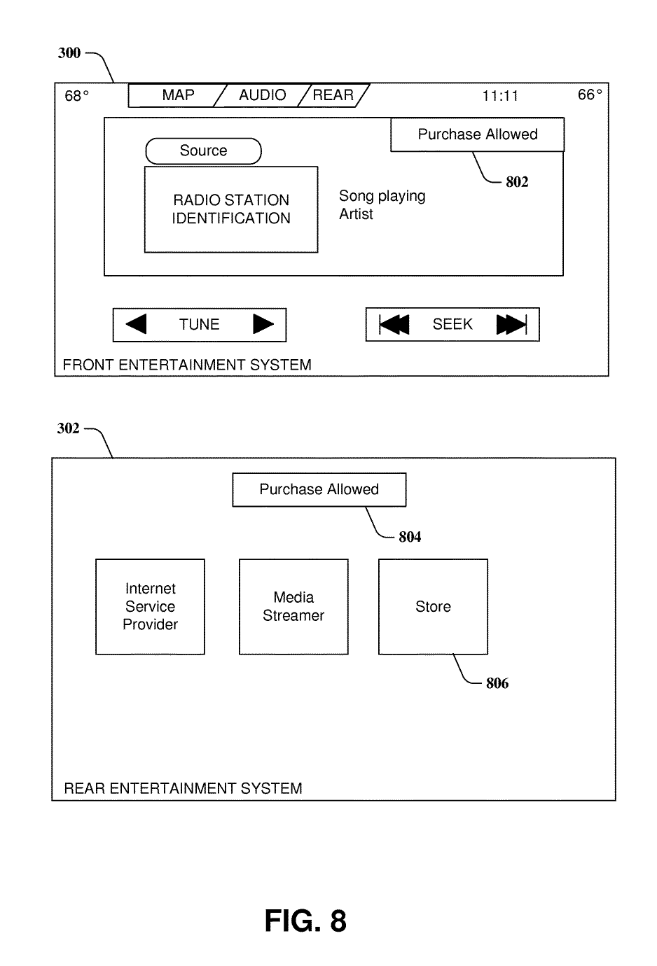

FIG. 8 illustrates an example, non-limiting representation of approval of a purchase request, according to an aspect. If the first selection 706 (of FIG. 7) is enabled (e.g., the purchase is allowed), the display of the front entertainment system 300 includes an indication 802 that the purchase was allowed. At the rear entertainment system 302, an approval message 804 is provided so that the user knows the purchase is authorized. Thus, the user may select the store 806 (in this example) and consume the item purchased.

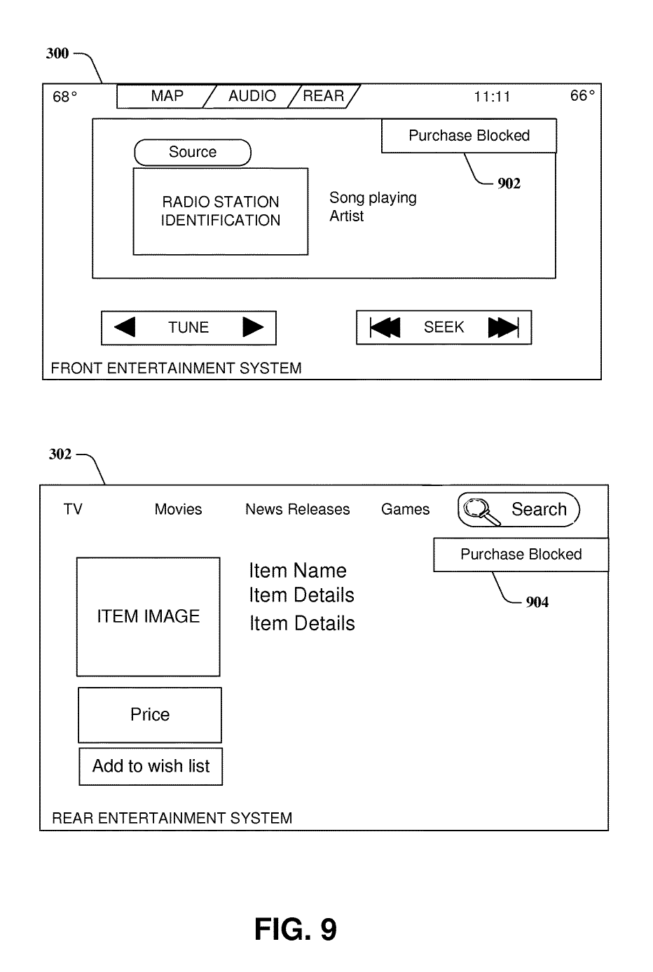

FIG. 9 illustrates an example, non-limiting representation of denial of a purchase request, according to an aspect. In this situation, the second selection 708 (of FIG. 7) is enabled (e.g., the purchase is blocked). Thus, an indication 902 is provided on the front entertainment system 300 and another indication 904 is provided on the rear entertainment system 302 indicating the purchase was blocked.

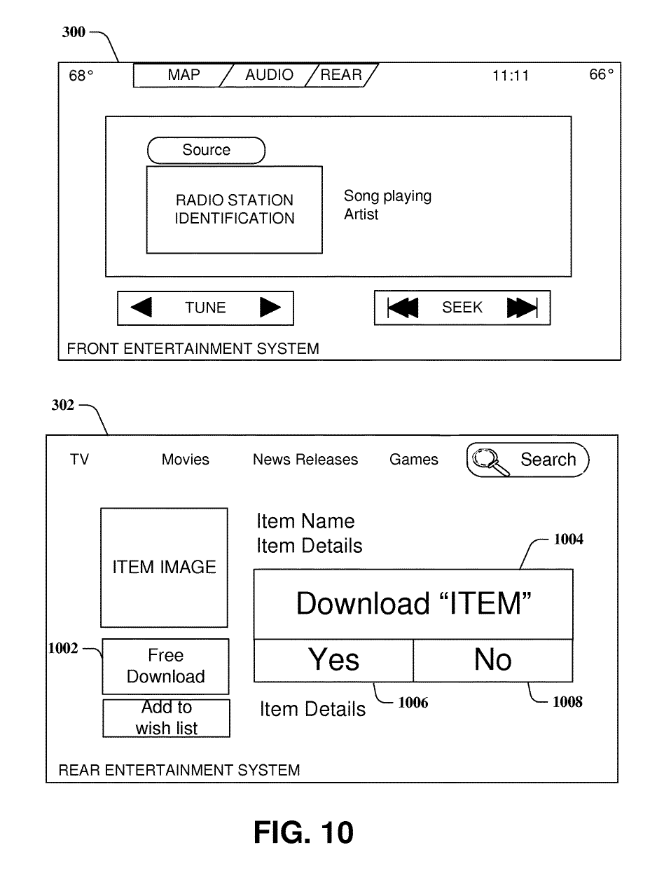

FIG. 10 illustrates an example, non-limiting representation of a download attempt, according to an aspect. As illustrated, the front entertainment system 300 and the rear operating system 302 are operating independently, as discussed with reference to FIG. 6.

As illustrated on the rear entertainment system 302, the user is interested in downloading free content and, therefore, may activate a “free download” option 1002. A confirmation 1004 is rendered on the display and the user is provided the opportunity to confirm the download 1006 (“YES”) or cancel the download 1008 (“NO”). If the user decides to cancel the download 1008, the download request is canceled and the user may proceed to search for another item. In this situation, no communication is sent to the front entertainment system 300.

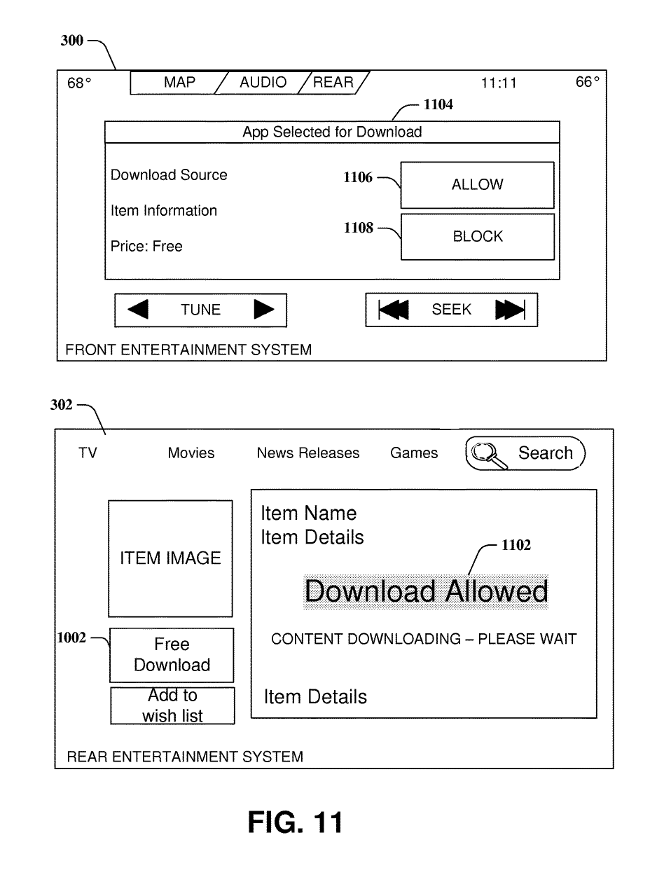

FIG. 11 illustrates an example, non-limiting representation of confirmation of a download attempt, according to an aspect. When the download 1006 (of FIG. 10) is confirmed, a status announcement 1102 is provided that indicates approval is authorized and according to some implementations, an indication is provided that the content is being downloaded.

From the perspective of the front entertainment system 300, a screen 1104 indicates an application has been selected for download (e.g., at the rear entertainment system 302). Further details related to the application (or other item) may be provided. Such details may include the download source, information about the item, and the price, which is free in this example. A user of the front entertainment system 300 is provided a first selection 1106 to allow the download, and a second selection 1108 to deny or block the download. If the first selection 1106 is chosen, the download is allowed. Therefore, the content may be downloaded at the rear entertainment system 302.

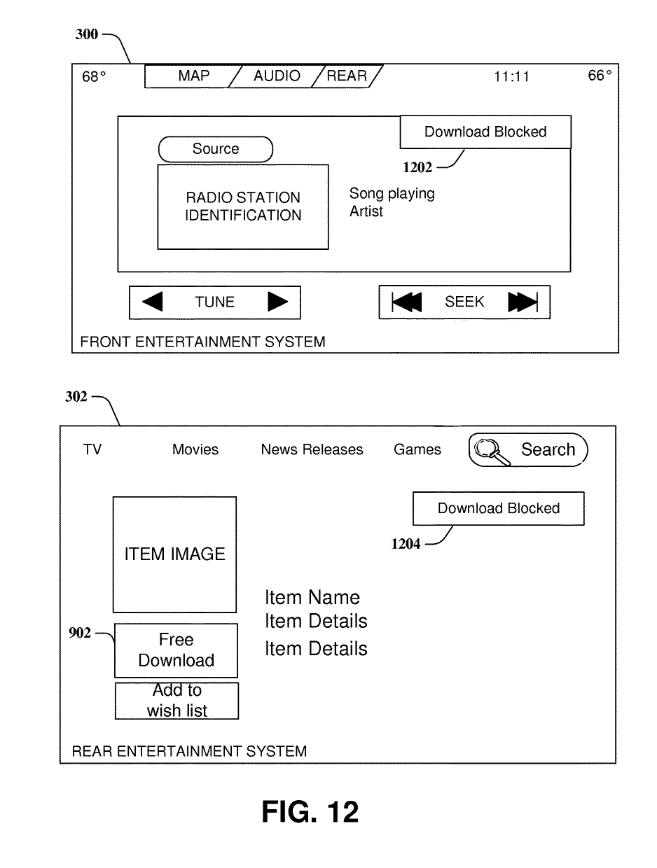

FIG. 12 illustrates an example, non-limiting representation of denial of a download request. Continuing the example of FIG. 11, if the second selection 1108 is chosen, the content is blocked and respective indicators may be provided. For example, a first message 1202 (e.g., download blocked) may be displayed on the front entertainment system 300 and a second message 1204 (e.g., download blocked) may be displayed on the rear entertainment system 302. Although not specifically mentioned, the various indicators, notifications, or other items displayed may be transparent or have other features (e.g., different color or font), as discussed herein. Further, the display of such indicators, notifications, or other items may be configurable such that a user may designate how the information should be displayed (or should be output in another format).

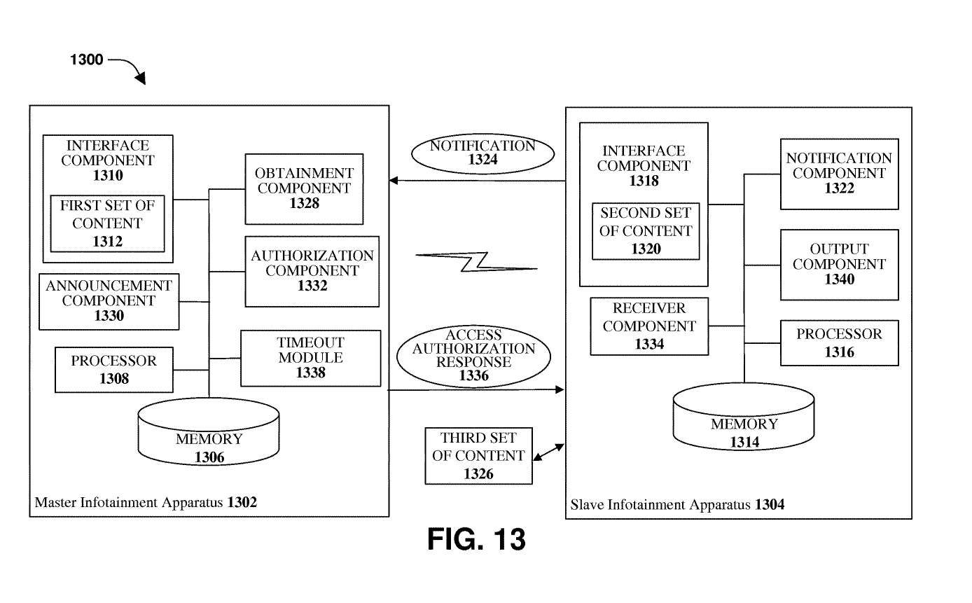

FIG. 13 illustrates an example, non-limiting system 1300 for communication between at least two infotainment apparatuses, according to an aspect. The system 1300 includes at least one master infotainment apparatus 1302 and at least one slave infotainment apparatus 1304. As used herein, the term “master” refers to a controlling infotainment apparatus and the term “slave” refers to an infotainment apparatus that is controlled, at least in part, by a master infotainment apparatus. Thus, a master infotainment apparatus may perform operations without obtaining approval from another entity (e.g., apparatus, system, and so on). Further, a slave infotainment apparatus may perform certain operations without approval, but for other operations, approval by another entity (e.g., apparatus, system) is needed before the slave infotainment apparatus may proceed with the operation.

According to an implementation, the master infotainment apparatus 1302 and the slave infotainment apparatus 1304 communicate over a wireless link, as illustrated. However, according to other implementations, the master infotainment apparatus 1302 and the slave infotainment apparatus 1304 communicate over a wired link (e.g., through a communications bus associated with a vehicle). Thus, the communication link between the master infotainment apparatus 1302 and the slave infotainment apparatus 1304 may be a communication link that allows communication flow between the apparatuses.

The master infotainment apparatus 1302 may include at least one memory 1306 that may store computer executable components and/or computer executable instructions and at least one processor 1308 that may facilitate execution of the computer executable components and/or the computer executable instructions stored in the memory 1306.

Also included in the master infotainment apparatus 1302 may be an interface component 1310 that may be configured to output a first set of content 1312 at the master infotainment apparatus 1302. For example, the interface component 1310 may be configured to output the first set of content 1312 on a display screen. Alternatively or additionally, the interface component 1310 may be configured to output the first set of content 1312 through audio speakers. According to some implementations, the interface component 1310 may be configured to receive one or more inputs or selections for operation of the at least one memory 1306 and/or the at least one processor 1308.

In a similar manner, the slave infotainment apparatus 1304 may include at least one memory 1314 that may store computer executable components and/or computer executable instructions and at least one processor 1316 that may facilitate execution of the computer executable components and/or the computer executable instructions stored in the at least one memory 1314.

The slave infotainment apparatus 1304 may also include an interface component 1318 that may be configured to output a second set of content 1320. The second set of content 1320 may be the same or similar to the first set of content 1312, or may be different from the first set of content 1312. For example, respective users might be listening to the same radio program and/or watching the same movie. In another example, the respective users may be watching the same movie, but be viewing different portions of the movie (e.g., a parent paused his movie while taking a business call, but the child kept watching his movie without interruption). In a further example, the child may be playing a game and a parent may be watching a movie. Thus, the first set of content 1312 may be consumed independent of the second set of content 1320.

The slave infotainment apparatus 1304 may also include a notification component 1322 that may be configured to convey an indication or notification 1324 to the master infotainment apparatus 1302 related to a third set of content 1326 attempting to be accessed. For example, a user may interact with the interface component 1318 and attempt to perform various functions with respect to content. Such functions may include downloading content, viewing content, purchasing content, as well as other functions that may trigger an authentication procedure, as discussed herein.

An obtainment component 1328 associated with the master infotainment apparatus 1302 may be configured to receive the notification 1324. Information related to the access attempt by the slave infotainment apparatus 1304 and information related to the third set of content 1326 may be rendered by the interface component 1310.

According to an implementation, an announcement component 1330 may be configured to provide details related to the third set of content 1326. For example, the details may include a name, a rating (e.g., movie rating), a genre, a summary, a source of the third set of content 1326, and so on. The details may be various information that may be useful for a user of the master infotainment system 1302 to make a decision related to whether the content is authorized content, or is not authorized content.

According to some implementations, the details provided by the announcement component 1330 are details requested by the user of the master infotainment apparatus 1302. For example, the requested details might be a viewer rating and a list of the actors in a movie, a price, and a comparison to related games, and so on.

An authorization component 1332 may be configured to control access to the third set of content 1326. Thus, the third set of content 1326 cannot be consumed by a user of the slave infotainment apparatus 1304 unless approval is received from the authorization component 1332. Such approval may be received at a receiver component 1334, for example, and may be received in the form of an access authorization response 1336.

According to an implementation, the determination by the authorization component 1332 may be made based on receipt of a manual input. For example, at about the same time as the indication and/or the details are conveyed to a user of the master infotainment apparatus 1302, at least two selectors may be provided. Selection of the first selector may indicate approval to access the third set of content 1326 and selection of the second selector may indicate approval to access the third set of content 1326 is denied. According to some implementations, a third selector (or additional selectors) may be provided. For example, more information might be needed from the slave infotainment apparatus 1304 and/or the user. Such information might be more details related to the third set of content 1326 and/or might be other information. For example, a parent might require a child to answer a question (e.g., a math equation, a history question, and so on) and, a correct answer might be needed before the parent will allow access. In such a manner, educational aspects may be incorporated with the disclosed aspects.

In additional or alternative implementations, the determination by the authorization component 1332 may be automatic based on defined rules (e.g., no user intervention is needed). Such rules may be enter by a user through interaction with the interface component 1310 or another system component. For example, if a movie viewing rating is PG-13 or lower, access to a download may be automatically granted, while ratings higher than PG-13 may be automatically denied. In another example, a child might be given a budget of $20.00 to spend during a trip. Thus, if a game or download costs less than the budget amount and other parameters are acceptable (e.g., a game rated for children as opposed to a game not suitable for children, a download is selected from a trusted source, and so on) the download or game is automatically approved. However, if the download is more than the budget amount (or a remaining budget amount), access may be automatically denied.

According to some implementations, a timeout module 1338 may be provided. Although illustrated and described with respect to the master infotainment apparatus 1302, a timeout module may also be included on the slave infotainment apparatus 1304 according to some implementations. The timeout module 1338 may be configured to monitor a length of time (or based on another interval) from when a request is rendered by the announcement component 1330 (or sent by the notification component 1322) to a current time. If the length of time is more than a configurable amount of time, the request may be automatically denied. The user of the slave infotainment component 1304 may proceed accordingly.

An output component 1340 may be configured to selectively allow access to the third set of content 1326. If approval or authorization is received (e.g., through the access authorization response 1336) by the receiver component 1334, the output component 1340 allows access to the third set of content 1326. However, if the grant access is denied (e.g., based on a time out module or through the access authorization response 1336), access to the third set of content 1326 is not allowed to proceed. In either case (acceptance or denial), the respective interface components 1310 and 1318 may output an indication such that the respective users know the status of the request.

Automated learning may be employed to facilitate one or more of the disclosed aspects. For example, a machine learning and reasoning component (not shown) may be utilized to automate one or more of the disclosed aspects. The machine learning and reasoning component may employ automated learning and reasoning procedures (e.g., the use of explicitly and/or implicitly trained statistical classifiers) in connection with performing inference and/or probabilistic determinations and/or statistical-based determinations in accordance with one or more aspects described herein.

For example, the machine learning and reasoning component may employ principles of probabilistic and decision theoretic inference. Additionally or alternatively, the machine learning and reasoning component may rely on predictive models constructed using machine learning and/or automated learning procedures. Logic-centric inference may also be employed separately or in conjunction with probabilistic methods.

The machine learning and reasoning component may infer whether an access request should be transmitted (by the slave infotainment apparatus 1304 of FIG. 13), whether an access request should be automatically accepted or denied (by the master infotainment apparatus 1302 of FIG. 13), and so on. Such inferences may be made by obtaining knowledge about the content, knowledge about restrictions placed on the content allowed, potential ramifications of allowing the content, the application/program context, or combinations thereof. Based on this knowledge, the machine learning and reasoning component may make an inference based on which actions to implement, which information would be useful for an access decision to be made, which content to allow, which content to prohibit, or combinations thereof.

As used herein, the term “inference” refers generally to the process of reasoning about or inferring states of the system, a component, a module, the environment, and/or one or more sets of content from a set of observations as captured through events, reports, data, and/or through other forms of communication. Inference may be employed to identify a specific context or action, or may generate a probability distribution over states, for example. The inference may be probabilistic. For example, computation of a probability distribution over states of interest based on a consideration of data and/or events. The inference may also refer to techniques employed for composing higher-level events from a set of events and/or data. Such inference results in the construction of new events and/or actions from a set of observed events and/or stored event data, whether or not the events are correlated in close temporal proximity, and whether the events and/or data come from one or several event and/or data sources. Various classification schemes and/or systems (e.g., support vector machines, neural networks, logic-centric production systems, Bayesian belief networks, fuzzy logic, data fusion engines, and so on) may be employed in connection with performing automatic and/or inferred action in connection with the disclosed aspects.

The various aspects (e.g., in connection with monitoring and selectively allowing access to content) may employ various artificial intelligence-based schemes for carrying out various aspects thereof. For example, a process for determining if certain information should be presented to facilitate an authorization request, if content access should be approved or denied, and so on may be enabled through an automatic classifier system and process.

A classifier is a function that maps an input attribute vector, x=(x1, x2, x3, x4, xn), to a confidence that the input belongs to a class. In other words, f(x)=confidence(class). Such classification may employ a probabilistic and/or statistical-based analysis (e.g., factoring into the analysis utilities and costs) to prognose or infer an action that should be employed related to content access. In the case of content, for example, attributes may be identification of the content attempting to be accessed and the classes may be information related to the content.

A support vector machine (SVM) is an example of a classifier that may be employed. The SVM operates by finding a hypersurface in the space of possible inputs, which hypersurface attempts to split the triggering criteria from the non-triggering events. Intuitively, this makes the classification correct for testing data that may be similar, but not necessarily identical to training data. Other directed and undirected model classification approaches (e.g., naïve Bayes, Bayesian networks, decision trees, neural networks, fuzzy logic models, and probabilistic classification models) providing different patterns of independence may be employed. Classification as used herein may be inclusive of statistical regression that is utilized to develop models of priority.

One or more aspects may employ classifiers that are explicitly trained (e.g., through a generic training data) as well as classifiers that are implicitly trained (e.g., by observing changes or updates to one or more electronic control units, by receiving extrinsic information, and so on). For example, SVM's may be configured through a learning or training phase within a classifier constructor and feature selection module. Thus, a classifier(s) may be used to automatically learn and perform a number of functions, including but not limited to determining according to a predetermined criteria when to implement an access request, what information to provide with the access request, when to automatically grant the access request, when to automatically deny the access request, and so forth. The criteria may include, but is not limited to, similar requests, historical information (e.g., whether the same or similar content was approved or denied in the past), and so forth.

Additionally or alternatively, an implementation scheme (e.g., a rule, a policy, and so on) may be applied to control and/or regulate access to content. In some implementations, based upon a predefined criterion, the rules-based implementation may automatically and/or dynamically interpret content information and automatically load and/or unload one or more content. In response thereto, the rule-based implementation may automatically interpret and carry out functions associated with the content access by employing a predefined and/or programmed rule(s) based upon any desired criteria.

Methods that may be implemented in accordance with the disclosed subject matter will be better appreciated with reference to the following flow charts. While, for purposes of simplicity of explanation, the methods are shown and described as a series of blocks, it is to be understood and appreciated that the disclosed aspects are not limited by the number or order of blocks, as some blocks may occur in different orders and/or at substantially the same time with other blocks from what is depicted and described herein. Moreover, not all illustrated blocks may be required to implement the disclosed methods. It is to be appreciated that the functionality associated with the blocks may be implemented by software, hardware, a combination thereof, or any other suitable means (e.g. device, system, process, component, and so forth). Additionally, it should be further appreciated that the disclosed methods are capable of being stored on an article of manufacture to facilitate transporting and transferring such methods to various devices. Those skilled in the art will understand and appreciate that the methods could alternatively be represented as a series of interrelated states or events, such as in a state diagram.

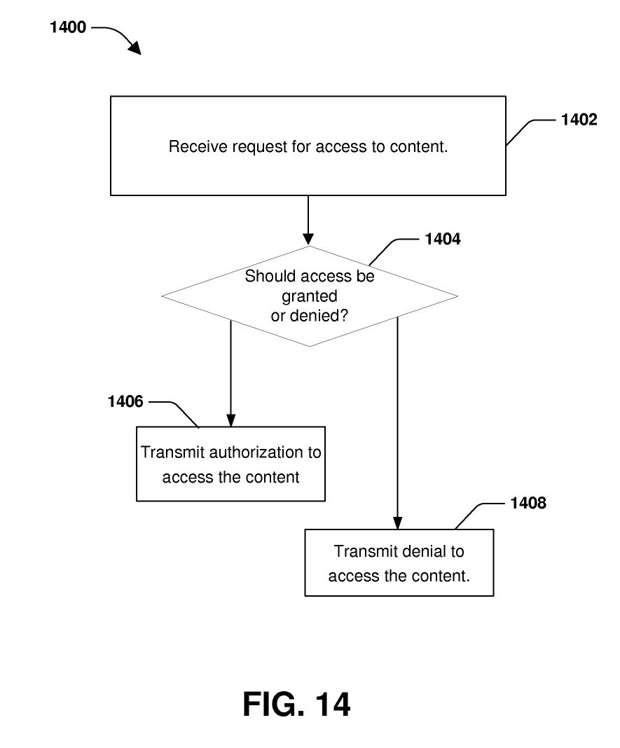

FIG. 14 illustrates an example non-limiting method 1400 configured for notification communication between entertainment systems, according to an aspect. The method 1400 may be implemented using any of the systems, such as the system 100 of FIG. 1, described herein. The disclosed aspects allows a user of a main or master entertainment (or infotainment) apparatus (referred to as a first system) to be aware of what another user of a secondary or slave entertainment (or infotainment) apparatus (referred to as a second system) is doing and allow access to certain content. The infotainment apparatuses may operate independently; however, the slave infotainment apparatus needs approval from the master slave infotainment apparatus to perform one or more actions.

At 1402, a request for access to content is received at a first system that includes a processor. The request may be received from a second system and related to content being accessed (e.g., purchased, downloaded, viewed, and so forth) at the second system.

A determination is made, at 1404, whether to grant or deny access to the content by the second system. The grant or deny decision may be made based on receipt of a manual input by a user of the first system, or may be determined automatically by the first system.

If the access is allowed, at 1406, an authorization to access the content may be transmitted to the second system. Alternatively, if access is denied, at 1408, a denial to access the content is transmitted to the second system.

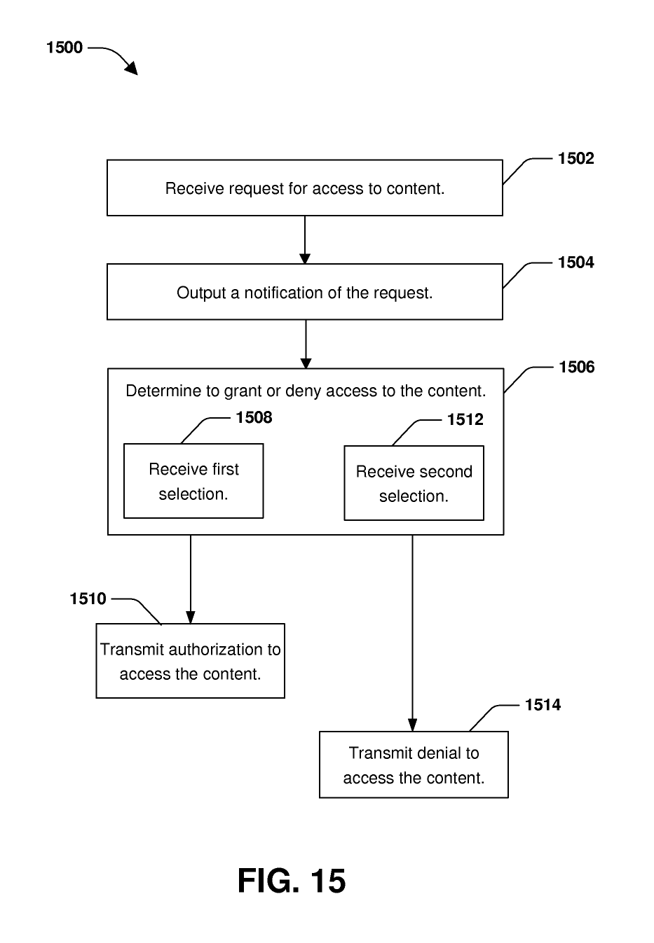

FIG. 15 illustrates an example, non-limiting method 1500 for selectively granting access to content, according to an aspect. The method 1500 may be implemented using any of the systems, such as the system 1300 of FIG. 13, described herein. At 1502, a request for access to content is received. The access request(s) may be received from one or more infotainment apparatuses that are being supervised by a main infotainment apparatus (or other device). The request might be triggered when content is being downloaded, viewed, purchased, or other actions are performed at the one or more supervised infotainment apparatuses. The request may include various information about the content. Such information may include a title, description, source, price, and so on.

At 1504, a notification of the request for access is output in a perceivable format. For example, the output may be in a visual format, such as on a display screen. In another example, the output may be in an audible format, such as through speakers. Additionally, details related to the content may also be output. The details may include information that would be useful when a decision related to granting or denying the access request is being made.

A determination is made, at 1506, whether to grant or deny access to the content. According to an implementation, at 1508, a first selection may be received, which indicates the access is approved. Thus, at 1510, an authorization to access the content is transmitted to the requesting apparatus.

According to another implementation, at 1512, a second selection may be received, which indicates the access is denied. Thus, at 1514, a denial of the access attempt is transmitted to the requesting apparatus.

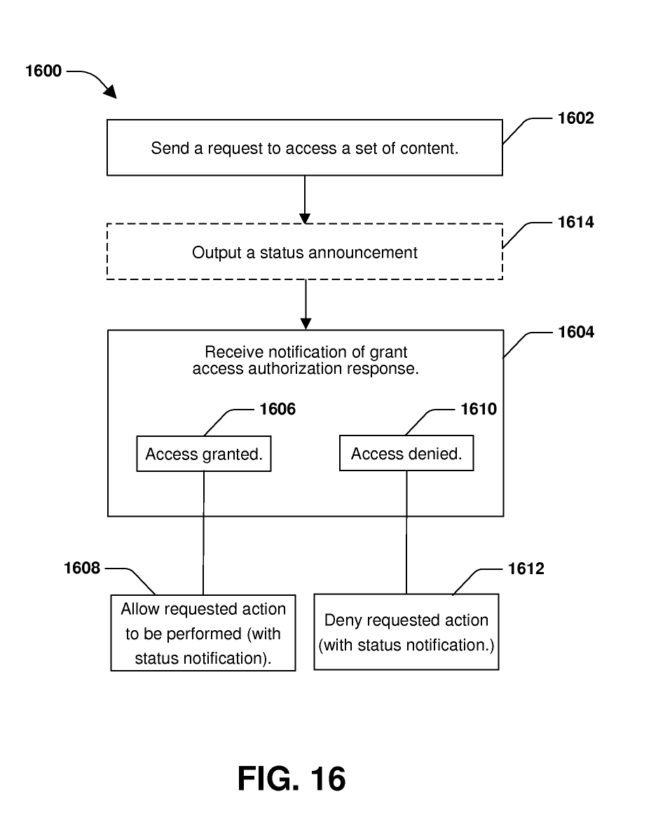

FIG. 16 illustrates an example, non-limiting method 1600 for accessing content on a supervised device, according to an aspect. The method 1600 may be implemented using any of the systems, such as the system 200 of FIG. 2, described herein.

Method starts, at 1602, when a request to access a set of content is sent from a supervised infotainment system to a supervisor infotainment system. The request may include the action being performed as well as information related to the content. The information related to the content might be supplied by a content provider or might be accessed over the Internet (e.g., a basic search automatically performed for related information).

At 1604, a response is received from the supervisor infotainment system. The response may be a grant access authorization or a denial of a grant access authorization. In the situation where the grant access authorization is received, at 1606, the desired action is allowed, at 1608. For example, if the requested action was to download the content, automatic download may begin. In another example, if the requested action was to purchase content, the purchase is resumed or completed. In a further example, if the requested action was to consume content, such as to view the content, the content is automatically displayed at the supervised infotainment system. In some implementations, a notification is also output that indicates the approval, such as approval message 804 of FIG. 8.

On the other hand, in the situation where the denial of the grant access authorization is received, at 1610, the desired action is denied, at 1612. For example, if the requested action was to download the content, the download is aborted. In another example, if the requested action was to purchase content, the purchase request is cancelled. In still another example, if the requested action was to consume the content, an error may occur and the content is not presented to the user. According to some implementations, a notification, such as the denial message 504 of FIG. 5, may be output so that the user is aware that the request was denied.

According to an implementation, at 1614, a status announcement may be output at the supervised infotainment system, such as status announcement 1102, of FIG. 11. The status announcement may be provided during pendency of the request to access the content, or after approval to access the content, according to an aspect.

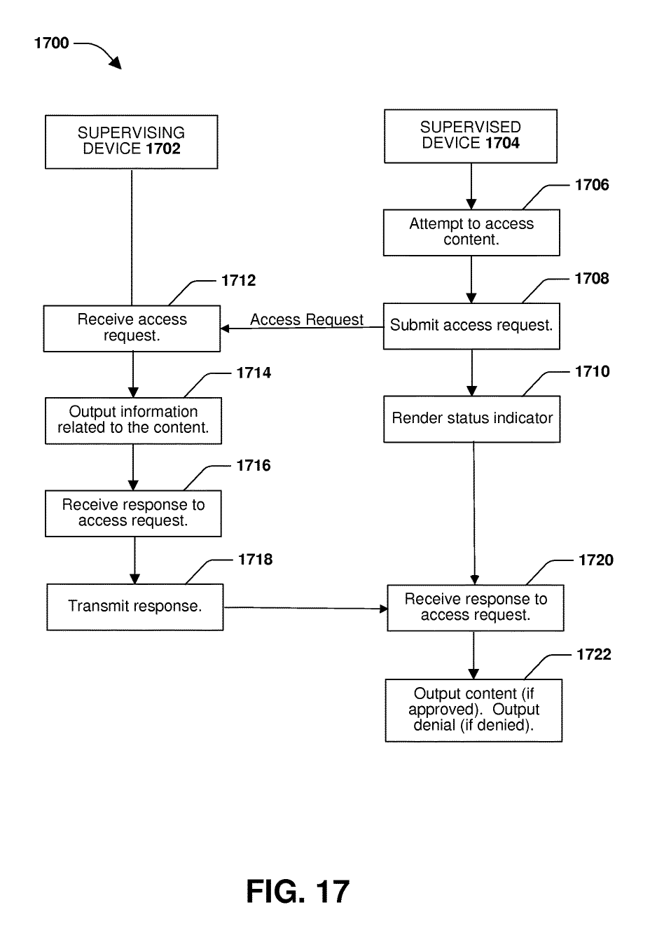

FIG. 17 illustrates an example, non-limiting method 1700 for communication notifications between at least two infotainment systems, according to an aspect. The method 1700 may be implemented using any of the systems, such as the system 1300 of FIG. 13, described herein.

Illustrated are a supervising device 1702 and a supervised device 1704. The supervising device 1702 (e.g., master device) may be operated by a parent or other person in authority. The supervised device 1704 (e.g., slave device) may be operated by a child or other person that requires supervision. According to some implementations, there may be more than one supervising device and/or more than one supervised device.

According to some implementations, the device supervision level may be changed. For example, a supervised device may be changed to be a supervising device, which may be a function of the location of the person in authority. Thus, if a parent decides to ride in the back of a vehicle (and a child in the front of the vehicle), the devices may be configured such that the supervising device is in the back of the vehicle and the supervised device is in the front of the vehicle. In an example, the supervision level may be based upon a user identification (e.g., sign-in passcode, biometrics, and so on).

Method 1700 begins, at 1706, when an attempt to access content is determined. The access attempt may be to purchase content, to download content, to view content, to send content, or to perform other actions with respect to content that was not previously authorized. Based on the access attempt, an access request is submitted, at 1708, to the supervising device 1702. According to some implementations, after, or at about the same time as, the access request is sent, a status indicator is rendered, at 1710, by the supervised device 1704. The status indicator may allow the user of the supervised device 1704 to determine that the request has been sent, but a response has not yet been received back from the supervising device 1702.

The access request is received by the supervising device 1702, at 1712. Information related to the content attempting to be accessed may be output for review and consideration, at 1714. According to some implementations, the information related to the content includes a title, a source, a price, a description, a rating, or other information. The information may be output to a user of the supervising device 1702, for example. Further, the information output may include a means for the user to accept and/or deny the request (e.g., the first selection 706 and the second selection 708 of FIG. 7).

According to some implementations, the information may be output to a component (such as the authorization component 1332 of FIG. 13) for automatic acceptance and/or denial of the access request. For example, there may be certain criteria established wherein if information associated with the content is below (or above) the criteria, the access request is automatically accepted (or denied). In one example implementation, if the viewing rating is at or below a PG-13 level, the access request is automatically granted. However, if the viewing rating is above a PG-13 level (such as an R rating), the access request is automatically denied.

At 1716, a response to the access request is received (e.g., from the authorization component 1332 of FIG. 13 or from a user). The response from the user might be received based on selection of an “approval” selector or a “block” selector. However, the disclosed aspects are not so limited and the response may be received in other formats (e.g., a verbal denial). In some implementations, if a response is not received within a configurable interval, the access request is automatically denied.

At 1718, the response to the access response is transmitted to the supervised device 1704. As indicated at 1720, the response to the access request is received by the supervised device 1704. If the access request is approved, the content is output, at 1722. Alternatively, if the access request is denied (or is a timeout period has elapsed), an indication of the denial is output, at 1722.

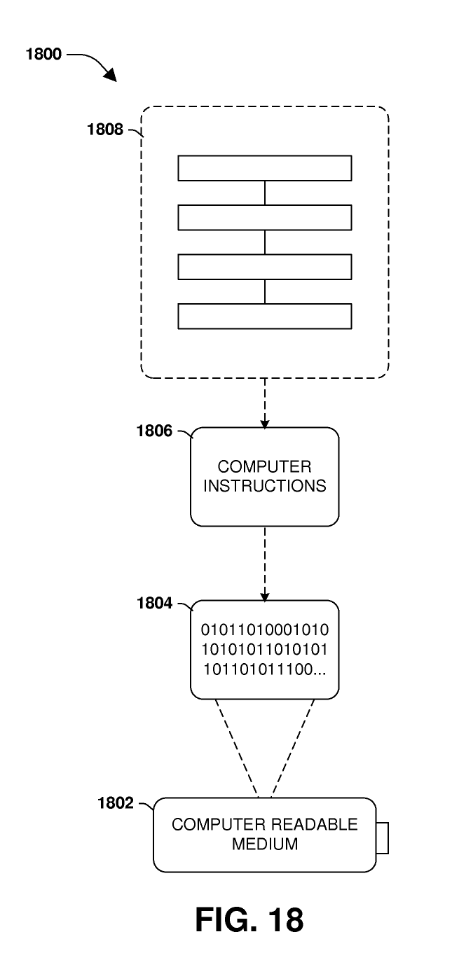

One or more implementations include a computer-readable medium including processor-executable instructions configured to implement one or more embodiments presented herein. An embodiment of a computer-readable medium or a computer-readable device devised in these ways is illustrated in FIG. 18, wherein an implementation 1800 includes a computer-readable medium 1802, such as a CD-R, DVD-R, flash drive, a platter of a hard disk drive, and so forth, on which is encoded computer-readable data 1804. The computer-readable data 1804, such as binary data including a plurality of zero's and one's as illustrated, in turn includes a set of computer instructions 1806 configured to operate according to one or more of the principles set forth herein.

In the illustrated embodiment 1800, the processor-executable computer instructions 1806 may be configured to perform a method 1808, such as the method 1400 of FIG. 14 and/or the method 1600 of FIG. 16, for example. In another embodiment, the processor-executable instructions 1804 may be configured to implement a system, such as the system 1300 of FIG. 13, for example. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter may be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

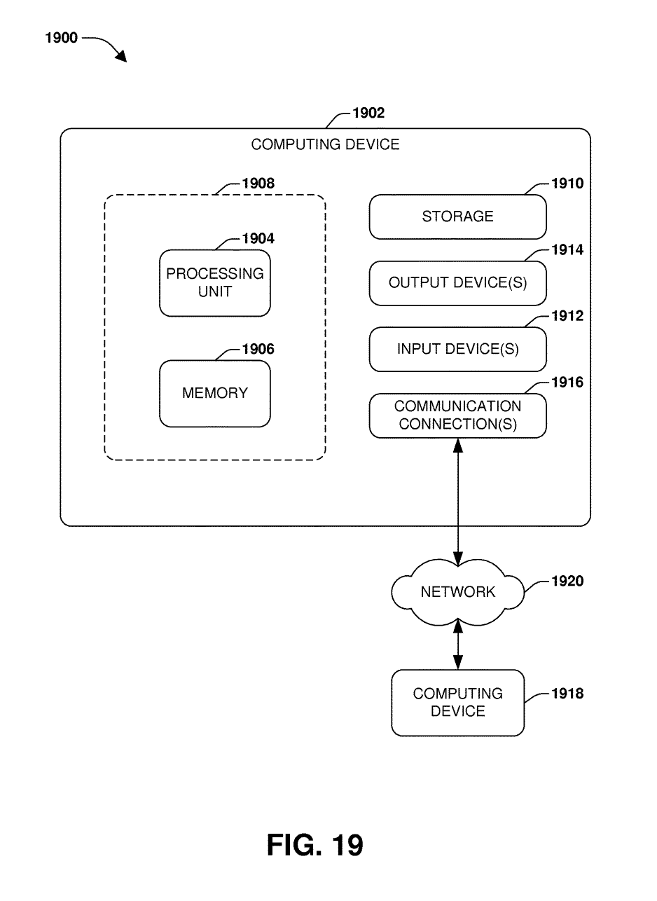

FIG. 19 and the following discussion provide a description of a suitable computing environment to implement embodiments of one or more of the aspects set forth herein. The operating environment of FIG. 19 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, embodiments are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 19 illustrates a system 1900 that may include a computing device 1902 configured to implement one or more embodiments provided herein. In one configuration, the computing device 1902 may include at least one processing unit 1904 and at least one memory 1906. Depending on the exact configuration and type of computing device, the at least one memory 1906 may be volatile, such as RAM, non-volatile, such as ROM, flash memory, etc., or a combination thereof. This configuration is illustrated in FIG. 19 by dashed line 1908.

In other embodiments, the device 1902 may include additional features or functionality. For example, the device 1902 may include additional storage such as removable storage or non-removable storage, including, but not limited to, magnetic storage, optical storage, etc. Such additional storage is illustrated in FIG. 19 by storage 1910. In one or more embodiments, computer readable instructions to implement one or more embodiments provided herein are in the storage 1910. The storage 1910 may store other computer readable instructions to implement an operating system, an application program, etc. Computer readable instructions may be loaded in the at least one memory 1906 for execution by the at least one processing unit 1904, for example.

Computing devices may include a variety of media, which may include computer-readable storage media or communications media, which two terms are used herein differently from one another as indicated below.

Computer-readable storage media may be any available storage media, which may be accessed by the computer and includes both volatile and nonvolatile media, removable and non-removable media. By way of example, and not limitation, computer-readable storage media may be implemented in connection with any method or technology for storage of information such as computer-readable instructions, program modules, structured data, or unstructured data. Computer-readable storage media may include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which may be used to store desired information. Computer-readable storage media may be accessed by one or more local or remote computing devices (e.g., via access requests, queries or other data retrieval protocols) for a variety of operations with respect to the information stored by the medium.

Communications media typically embody computer-readable instructions, data structures, program modules, or other structured or unstructured data in a data signal such as a modulated data signal (e.g., a carrier wave or other transport mechanism) and includes any information delivery or transport media. The term “modulated data signal” (or signals) refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

The device 1902 may include input device(s) 1912 such as keyboard, mouse, pen, voice input device, touch input device, infrared cameras, video input devices, or any other input device. Output device(s) 1914 such as one or more displays, speakers, printers, or any other output device may be included with the device 1902. The input device(s) 1912 and the output device(s) 1914 may be connected to the device 1902 via a wired connection, wireless connection, or any combination thereof. In one or more embodiments, an input device or an output device from another computing device may be used as the input device(s) 1912 and/or the output device(s) 1914 for the device 1902. Further, the device 1902 may include communication connection(s) 1916 to facilitate communications with one or more other devices, illustrated as a computing device 1918 coupled over a network 1920.

Although the subject matter has been described in language specific to structural features or methodological acts, it is to be understood that the subject matter of the appended claims is not necessarily limited to the specific features or acts described above. Rather, the specific features and acts described above are disclosed as example embodiments.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or.” Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first,” “second,” or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising,” “comprises,” “including,” “includes,” or the like generally means comprising or including.

Although the disclosure has been shown and described with respect to one or more implementations, equivalent alterations and modifications will occur based on a reading and understanding of this specification and the annexed drawings. The disclosure includes all such modifications and alterations and is limited only by the scope of the following claims.

1. An entertainment system for notification communication between vehicle entertainment systems, comprising:
a processor that executes the following computer executable components stored in a memory:
an interface component that outputs a first set of content at the entertainment system in a vehicle, independent of another entertainment system that is in the vehicle and outputs a second set of content;
an obtainment component that receives an indication that the other entertainment system is attempting to access a third set of content; and
an authorization component that controls access to the third set of content by the other entertainment system.

2. The entertainment system of claim 1, further comprising:
an announcement component that provides details related to the third set of content.

3. The entertainment system of claim 1, wherein the authorization component grants access to the third set of content based upon a determination that access to the third set of content is approved.

4. The entertainment system of claim 1, wherein the authorization component prohibits access to the third set of content based on a determination that access to the third set of content is denied.

5. The entertainment system of claim 1, wherein the interface component outputs the first set of content and the indication on a display screen.

6. The entertainment system of claim 1, wherein the indication is overlaid on a portion of the first set of content.

7. The entertainment system of claim 1, wherein the interface component outputs the first set of content audibly.

8. The entertainment system of claim 7, wherein the output of the first set of content is paused during output of the indication.

9. The entertainment system of claim 1, wherein the entertainment system and the other entertainment system comprises a master slave relationship.

10. The entertainment system of claim 1, wherein the indication comprises data related to a purchase of the third set of content.

11. The entertainment system of claim 1, wherein the indication comprises data related to a download of the third set of content.

12. A method for providing interactive notification communication between at least two vehicle entertainment systems, comprising:
receiving, using a first vehicle entertainment system processor, by a first vehicle entertainment system comprising the first vehicle entertainment system processor, a request for access to content by a second vehicle entertainment system comprising a second vehicle entertainment system processor, wherein the request is received from the second vehicle entertainment system;
determining, using the first vehicle entertainment system processor, by the first vehicle entertainment system, to grant or deny access to the content by the second vehicle entertainment system; and
transmitting, using the first vehicle entertainment system processor, by the first vehicle entertainment system, an authorization to access the content based on a determination to grant access to the content, or a denial to access the content based on another determination to deny access to the content, wherein the first vehicle entertainment system and the second vehicle entertainment system are in the same vehicle and operate independently.

13. The method of claim 12, wherein the determining comprises:
outputting a notification of the request for access and details related to the content; and
determining, based on receipt of a first selection that access to the content is approved and, based on another receipt of a second selection that access to the content is denied.

14. The method of claim 12, wherein the receiving comprises receiving the request based on an attempt to purchase the content at the second vehicle entertainment system.

15. The method of claim 12, wherein the receiving comprises receiving the request based on an attempt to download the content at the second vehicle entertainment system.

16. An entertainment system for notification communication between entertainment systems, comprising:
a processor that executes the following computer executable components stored in a memory:
an interface component that outputs a first set of content at the entertainment system in a vehicle, independent of another entertainment system that is in the vehicle and outputs a second set of content;
a notification component that conveys an indicator to the other entertainment system based on a determination that the entertainment system is attempting to access a third set of content; and
an output component that performs one of the following:
allows access to the third set of content based on receipt of a grant access authorization from the other entertainment system; and
prohibits access to the third set of content based on a denial of the grant access authorization from the other entertainment system.

17. The entertainment system of claim 16, further comprising:
a status indicator component that renders an indication of a state of the grant access authorization from the other entertainment system.

18. The entertainment system of claim 16, wherein the access is an attempt to purchase the third set of content.

19. The entertainment system of claim 16, wherein the access is an attempt to download the third set of content.

20. The entertainment system of claim 16, wherein the interface component outputs the first set of content on a first display screen.
